(19) United States
(12) Patent Application Publication
(10) Pub. No.: US 2024/0308814 A1
(43) Pub. Date: Sep. 19, 2024

(54) ELEVATOR SAFETY SYSTEM, ELEVATOR SYSTEM AND ELEVATOR CAR RESCUE RUN METHOD

(71) Applicant: KONE Corporation, Helsinki (FI)

(72) Inventors: Ari JUSSILA, HELSINKI (FI); Toni HIRVONEN, HELSINKI (FI); Atso KOSKINEN, HELSINKI (FI)

(73) Assignee: KONE Corporation, Helsinki (FI)

(21) Appl. No.: 18/434,101

(22) Filed: Feb. 6, 2024

(30) Foreign Application Priority Data
Mar. 14, 2023 (EP) 23161674.9

(51) Int. Cl. B66B 5/02; B66B 1/28; B66B 1/34

(52) U.S. Cl. CPC B66B 5/027; B66B 1/28; B66B 1/3461

(57) ABSTRACT

An elevator safety system includes: an electronic safety controller; at least one safety sensor providing safety-related information; at least one dual-channel safety node communicatively connected to the safety controller and configured to obtain safety-related information from the at least one safety sensor; and a safety diagnostics configured to: detect a single-channel failure of the at least one dual-channel safety node, and in response to detecting a single-channel failure, determine integrity of the obtained safety-related information. In case the safety-related information was determined intact, the safety controller is configured to generate a command allowing a rescue run of an elevator car to a rescue floor using said safety-related information. An elevator system and an elevator car rescue run method are also disclosed.

### FIELD OF THE INVENTION

The invention relates to an elevator safety system, an elevator system and an elevator car rescue run method. The elevator is preferably an elevator for transporting passengers and/or goods.

### BACKGROUND OF THE INVENTION

An elevator may comprise an elevator car and a hoisting machinery operable to drive the car in an elevator shaft, to transfer passengers and/or cargo between landings. The hoisting machinery may comprise an electrical motor for driving the car, as well as hoisting machinery brakes configured to apply to a traction sheave or a rotating axis of the hoisting machinery, to stop movement of the car or hold the car standstill at a landing in the shaft.

An elevator may have a safety system comprising an electronic safety controller and a plurality of safety nodes connected to the electronic safety controller via a communication channel, such as a data bus. There may be safety nodes disposed e.g. at landing floors, in an elevator shaft, in a machine room (if any)—and/or at the car. Safety nodes may be configured to monitor different aspects of elevator safety. Safety node(s) may be connected to safety contacts and/or other sensors, such as limit switches, position/speed sensors and/or cameras for the safety monitoring. If a safety-related problem was detected, such as an overspeed situation or opening of a landing door during an elevator run, the safety controller commands an actuator, such as a mechanical brake and/or an elevator drive unit, to immediately stop elevator car movement. This operation is referred to as an emergency stop.

An emergency stop will take place also in case of a safety node failure, for example a cable or a connector problem, rendering the elevator inoperative. If there are passengers inside the car in said emergency stop situation, a service technician has to visit the elevator site and release the passengers, by driving the car manually with a low speed to a rescue floor, which is usually the closest possible landing floor. To move the car the service technician has to press a manual drive button and also has to bypass the failed safety node by operating a manual bypass element.

This operation, also referred to as a rescue run, may include some problems. Firstly, it may take a long time for the service technician to travel to the elevator site, meaning an uncomfortably long waiting time for the trapped passengers. Secondly, bypassing the (entire) safety node means, that it is inoperable to perform any safety monitoring during the rescue run. Thus safety level of the elevator during said rescue run may be lower than desired.

### SUMMARY OF THE INVENTION

The objective of the invention is to solve one or more of the afore-mentioned problems by introducing an elevator safety system, an elevator system, and an elevator car rescue run method.

A new kind of a safety system and procedure for entrapment avoidance is provided. This procedure enables stopping of the elevator car at a landing floor, such that passengers can be released from the car, even in a case of a failure of an elevator safety node.

The elevator safety system according to the invention is defined in claim 1.

The elevator safety system comprises
an electronic safety controller; at least one safety sensor providing safety-related information; at least dual-channel safety node communicatively connected to the electronic safety controller and configured to obtain safety-related information from the at least one safety sensor; and
a safety diagnostics configured to: detect a single-channel failure of the at least one dual-channel safety node, and in response to detecting a single-channel failure, determine integrity of the obtained safety-related information;
wherein, in case the safety-related information was determined intact, the safety controller is configured to generate a command allowing a rescue run of an elevator car to a rescue floor using said safety-related information.

The elevator system according to the invention is defined in claim 11.

The elevator system comprises an elevator shaft and an elevator car configured to transfer passengers and/or cargo in the elevator shaft between landing floors, and an elevator safety system as described above or in the following allowing a rescue run of the car to a rescue floor.

The elevator car rescue run method is defined in claim 12.

The elevator car rescue run method in an elevator system as described above or in the following comprises: obtaining by the at least one dual-channel safety node safety-related information from the safety sensor; detecting by the safety diagnostics a single-channel failure of the at least one dual-channel safety node; and in response to detecting a single-channel failure, determining integrity of the obtained safety-related information;
wherein, in case the safety-related information was determined intact, generating by the safety controller a command allowing a rescue run of the car to a rescue floor using said safety-related information.

Preferable further embodiments of the invention are introduced in the following and in the appended dependent claims, which further embodiments can be combined individually or in any combination.

According to an embodiment, said at least one dual-channel safety node has a duplicated and redundant, fail-safe processing structure.

According to an embodiment, said at least one dual-channel safety node is communicatively connected to the safety controller via duplicated messaging, preferably via a duplicated data bus.

According to an embodiment, duplicated data is transferred via both data buses of the duplicated data bus between the at least one dual-channel safety node and the safety controller.

According to an embodiment, the single-channel failure is a single-channel failure of one of said data buses, in particular a single cable problem or a single connector problem or a single data transceiver problem, or electric interference, such as common-mode interference that disturbs data communication.

According to an embodiment, the at least one dual-channel safety node comprises two safety inputs connected to the safety sensor.

According to an embodiment, the single-channel failure is failure of one of two safety inputs comprised by the at least one dual-channel safety node.

According to an embodiment, the at least one safety sensor is connected to the at least one dual-channel safety node.

According to an embodiment, the at least one safety sensor comprises a safety contact and/or other sensor, such as a limit switch, a position sensor, a speed sensor or a camera.

According to an embodiment, at least one safety sensor comprises two position sensors and/or two speed sensors for increased reliability and safety.

According to an embodiment, the at least one dual-channel safety node is disposed in the car, and the at least one safety sensor is one of a car pulley encoder, a door zone sensor, a car door contact, and a safety contact of an elevator safety gear.

According to an embodiment, the safety diagnostics is a separate diagnostics device, or a diagnostics function implemented in a software comprised by the at least one dual-channel safety node and/or by the safety controller.

According to an embodiment, the safety controller comprises a programmable safety device designed to fulfil specific safety requirements, such as in line with IEC 61508 safety standard for functional safety.

According to an embodiment, the elevator system comprises a measurement system configured to provide an indication of the elevator car position and/or speed in the shaft.

According to an embodiment the position sensor and/or the speed sensor comprised by the measurement system is selected from one or more of a motor encoder, a car encoder, a door zone sensor, a measurement strip extending in the shaft next to elevator car trajectory.

According to an embodiment, the measurement system comprises two position sensors and/or two speed sensors for increased reliability and safety.

According to an embodiment, the safety controller is configured to receive information from the measurement system to monitor the elevator car position and/or speed in the shaft.

An exemplary elevator system comprises an elevator car and an elevator shaft. The elevator car transfers passengers and/or cargo in the elevator shaft between landings in the shaft. The exemplary elevator system also comprises an elevator hoisting machinery operable to drive the elevator car that generates driving torque to drive the car. Movement of the car is managed by an elevator control, which generates control commands needed to drive the hoisting machinery.

According to an embodiment, the hoisting machinery comprises machinery brakes to apply to a traction sheave or a rotating axis of the hoisting machinery, to stop movement of the car or hold the car standstill at a landing in the shaft.

Further, the exemplary elevator system comprises a safety system. The safety system comprises a safety controller, which is according to an embodiment a programmable electronic safety controller, which receives information from the measurement system such that it can monitor the elevator car position and/or speed in the shaft.

According to an embodiment, the elevator car rescue run method comprises continuing current elevator run as a rescue run to the rescue floor; or performing a new, low-speed rescue run after stopping of the car.

According to an embodiment, the method comprises performing the rescue run automatically upon occurring of an emergency stopping situation; or initiating the rescue run locally on-site by pressing a manual drive button; or initiating the rescue run remotely by sending a message from a remote entity, such as a service center.

According to an embodiment, the method comprises: after arrival of the car to the rescue floor, preventing by the safety system a next elevator run and shutting down operation of the elevator until the diagnosed failure has been repaired.

Movement of the elevator car to the rescue floor can be allowed in rescue drive mode without operating manually a rescue drive function switch and without bypassing the failed safety node.

There is no need to bypass safety controller safety inputs, possible door zone sensor nodes, or position sensor nodes to make evacuation run to a floor in rescue drive function mode, when communication in one safety node channel has been lost. Passenger evacuation can also be carried out by an instructed person (e.g. a janitor), as there is no need for bypass jumpers and no safety contacts are bypassed.

### BRIEF DESCRIPTION OF THE DRAWINGS

The invention will in the following be described in greater detail by means of preferred embodiments with reference to the attached drawings, in which:

FIG. 1 shows an elevator system provided with a safety system, and

FIG. 2 shows a block diagram of some elements of the elevator system.

### DETAILED DESCRIPTION

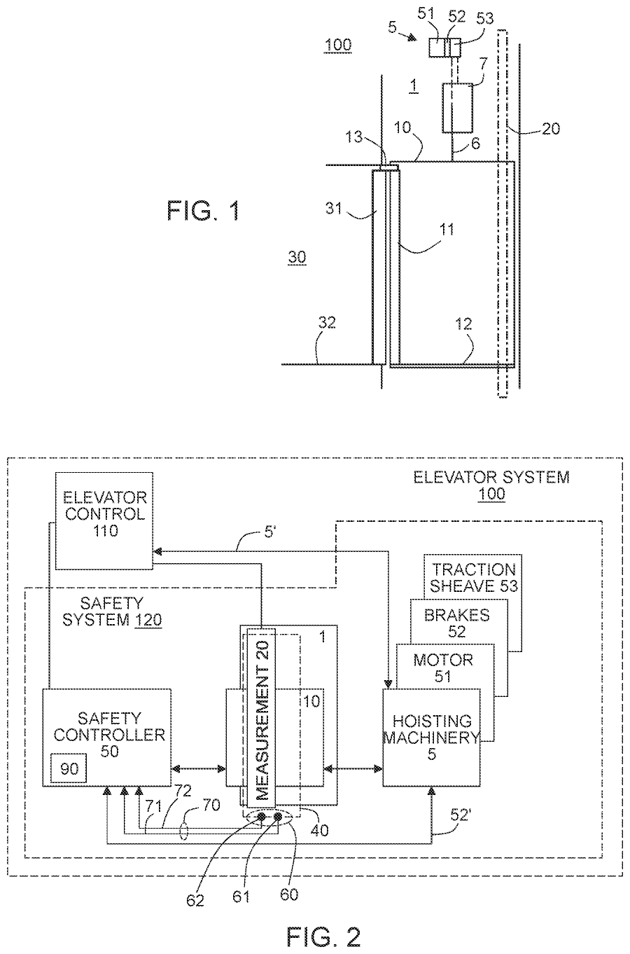

FIG. 1 schematically illustrates some aspects of an exemplary elevator system 100 comprising an elevator car 10 and a hoisting machinery 5 operable to drive the car 10 in an elevator shaft 1, to transfer passengers and/or cargo between landing floors 32 of landings 30.

The elevator system 100 in FIG. 1 comprises an elevator control 110, which comprises an elevator control unit and a drive unit, such as a frequency converter. The elevator control 110 generates control commands 5′ needed to drive the hoisting machinery 5 and manages the movement of the car 10. The hoisting machinery 5 comprises an electrical motor 51 for driving the car 10, as well as hoisting machinery brakes 52 configured to apply to a traction sheave 53 or a rotating axis of the hoisting machinery, to stop movement of the car or hold the car standstill at a landing 30 in the shaft 1. More generally, the elevator system comprises at least one mechanical brake to stop movement of the car or hold the car standstill in the shaft 1. The elevator system in FIG. 1 has hoisting ropes 6 supporting the car 10, running via the traction sheave 53, and connected to a counterweight 7.

The car 10 is provided with a car door 11 and a car floor 12. The car door 11 comprises a door that may be moved between a closed position and an open position. The car door 11 may be kept locked while the car 10 is moving, unlocked upon the car 10 entering a landing zone located at and close to a landing 30 provided with a landing floor 32 and opened upon the car 10 stopping at the landing 30. The car door 11 may be closed before the car 10 leaves the landing 30 and locked upon the car 10 exiting the landing zone. The car 10 is provided with a door operator 13 connected to the car door 11 for temporarily coupling the car door 11 to a landing door 31 provided at each landing 30 when the car 10 resides within the landing zone of the landing 30 such that the landing door 31 moves between a closed position and an open position together with the car door 11, thereby allowing passengers to move between the landing floor 32 and the car 10 when the car 10 is at the landing 30 while preventing the passengers from entering the shaft 1 when the elevator car 10 is not at the landing 30.

The elevator system in FIG. 1 comprises a measurement system 20 configured to provide an indication of the elevator car 10 position and/or speed in the shaft 1. The measurement system 20 may comprise e.g. one or more of: a motor encoder; a car encoder; a door zone sensor e.g. providing position information of the elevator car 10 in the vicinity of each landing floor 32; a measurement strip extending in the shaft next to elevator car trajectory such as an optically or magnetically readable tape extending in the shaft.

FIG. 2 shows an exemplary block diagram of some elements of the elevator system 100.

The elevator system 100 comprises a safety system 120. The safety system in FIG. 2 comprises a programmable electronic safety controller 50. The safety controller 50 is configured to generate a command allowing a rescue run of the car 10 to a rescue floor 32 using safety-related information obtained from at least one safety sensor 40.

Preferably the safety controller 50 receives information from the measurement system 20 such that it can monitor the elevator car 10 position and/or speed in the shaft 1. The safety controller 50 may be a programmable safety device designed to fulfil specific safety requirements, such as in line with IEC 61508 safety standard for functional safety.

The elevator safety system 120 comprises at least one safety sensor 40 providing safety-related information.

The elevator safety system 120 further comprises at least one dual-channel safety node 60 communicatively connected to the electronic safety controller 50 and configured to obtain safety-related information from the at least one safety sensor 40. The term “dual-channel safety node” means that said node is a processing unit 60, in other words a physical electronic device 60, that has a duplicated and redundant, fail-safe processing structure. Said safety node 60 is capable of creating, receiving, or transmitting information over a communication channel.

In FIG. 2, the at least one safety sensor 40 is connected to the at least one dual-channel safety node 60 to provide safety-related information of the elevator system 100.

According to an embodiment said at least one safety sensor 40 is a safety contact and/or other sensor, such as a limit switch, position/speed sensor or a camera.

According to an embodiment said at least one dual-channel safety node 60 is communicatively connected to the electronic safety controller 50 via duplicated messaging, preferably via a duplicated data bus 70, such that the same, duplicated data is transferred via both data buses 71; 72 between at least one dual-channel safety node 60 and the safety controller 50.

The elevator safety system 120 further comprises a safety diagnostics 90 configured to: detect a single-channel failure of the at least one dual-channel safety node 60, and in response to detecting a single-channel failure of the at least one dual-channel safety node 60, determine integrity of the obtained safety-related information, i.e. whether said safety-related information is intact or not. In case the safety-related information was determined intact and can also be received by the safety controller 50 via the still operating channel, in which the status of the car safety devices and contacts is still available, the safety controller 50 is configured to generate a command allowing a rescue run to the rescue floor 32 using said safety-related information.

The safety diagnostics 90 may be a separate diagnostics device, or a diagnostics function implemented in a software comprised by the at least one dual-channel safety node 60 and/or by the safety controller 50. In the example of FIG. 2, the safety diagnostics shown as a diagnostics function implemented in a software of the safety controller 50.

According to an embodiment the single-channel failure is a single-channel failure of one of said data buses 71;72, in particular a single cable problem or a single connector problem or a single data transceiver problem.

According to an embodiment the at least one dual-channel safety node 60 comprises two safety inputs 61;62 connected to and reading the at least one safety sensor 40.

According to an embodiment the single-channel failure is failure of one of the safety inputs 61;62.

According to an embodiment the at least one safety sensor 40 comprises a safety contact and/or other sensor, such as a limit switch, a position sensor, a speed sensor, or a camera.

According to an embodiment the at least one dual-channel safety node 60 is disposed in the car 10, and the at least one safety sensor 40 is one of a car pulley encoder, a door zone sensor, a car door contact, and a safety contact of an elevator safety gear.

According to an embodiment the safety controller 50 is incorporated in a main safety controller of the elevator system, where the function limiting the travel path of the car may be implemented with position, time, and speed limits.

According to another embodiment the safety controller 50 is located in a drive controller of the elevator system.

According to an embodiment at least one mechanical brake 52 of the elevator system causing the car 10 to stop in the shaft 1, for example the hoisting machinery brakes 52, is triggered 52′ by the elevator safety system 120 in some predetermined situations.

According to an embodiment, the measurement system 20 comprises two position sensors and/or two speed sensors for increased reliability and safety.

The elevator car 10 rescue run method in the elevator system 100 comprises: obtaining by the at least one dual-channel safety node 60 safety-related information from the safety sensor 40; detecting by the safety diagnostics 90 a single-channel failure of the at least one dual-channel safety node 60; and in response to detecting a single-channel failure, determining integrity of the obtained safety-related information; and in case the safety-related information was determined intact, generating by the safety controller 50 a command allowing a rescue run of the car 10 to the rescue floor 32 using said safety-related information.

According to an embodiment current elevator run is continued as a rescue run to the rescue floor 32; or a new, low-speed rescue run is performed after stopping of the car 10.

According to an embodiment the rescue run is performed automatically upon occurring of an emergency stopping situation, or the rescue run is initiated locally on-site by pressing a manual drive button, or the rescue run is initiated remotely by sending a message from a remote entity, such as a service center.

According to an embodiment, after arrival of the car 10 to the rescue floor 32, preventing by the safety system 120 a next elevator run and shutting down operation of the elevator until the diagnosed failure has been repaired.

According to an example the elevator control 110 comprises a main safety controller and two car safety controller boards for connecting car safety devices and contacts. According to the example the safety controller boards are connected to the main safety controller via two time triggered safety (TTS) channels and each channel provides the status of the car safety devices and contacts to the main safety controller. According to the example nodes connected to the TTS bus are e.g. the car safety controller board, a door zone sensor, and the main safety controller. If the safety system has failed in such way that TTS communication between the main safety controller and a safety controller board has been lost in one channel only the status of the car safety devices and contacts is still available in one channel. When the main safety controller detects that a car safety controller board has gone missing in either channel it shall check that safety controller safety input data is reliable. If the car safety controller board status in the available channel is verified OK, the safety controller board has verified that a processor in the missing safety channel is working and communicating between channels and also safety inputs are in same states between channels. This means that the statuses of the car safety controller board safety inputs are read and transferred to the main safety controller reliably. Thereafter the main safety controller shall allow rescue run (movement in rescue drive function RDF mode) without using bypass jumpers. Thus, there is no need to bypass car safety controller boards safety inputs and door zone sensor and absolute position sensor nodes to make evacuation run to a floor when communication in one TTS channel between the main safety controller and a sensor such as the safety controller board or door zone sensor or the absolute position sensor has been lost.

The use of the invention is not limited to the embodiments disclosed in the figures. It will be obvious to a person skilled in the art that, as the technology advances, the inventive concept can be implemented in various ways. The invention and its embodiments are not limited to the examples described above but may vary within the scope of the claims.

1. An elevator safety system comprising:
an electronic safety controller;
at least one safety sensor providing safety-related information;
at least one dual-channel safety node communicatively connected to the safety controller and configured to obtain safety-related information from the at least one safety sensor; and
a safety diagnostics configured to:
detect a single-channel failure of the at least one dual-channel safety node; and
in response to detecting a single-channel failure, determine integrity of the obtained safety-related information,
wherein, in case the safety-related information was determined intact, the safety controller is configured to generate a command allowing a rescue run of an elevator car to a rescue floor using said safety-related information.

2. The elevator safety system according claim 1, wherein said at least one dual-channel safety node has a duplicated and redundant, fail-safe processing structure.

3. The elevator safety system according to claim 1, wherein said at least one dual-channel safety node is communicatively connected to the safety controller via duplicated messaging, preferably via a duplicated data bus.

4. The elevator safety system according to claim 3, wherein duplicated data is transferred via both data buses of the duplicated data bus between the at least one dual-channel safety node and the safety controller.

5. The elevator safety system according to claim 3, wherein the single-channel failure is a single-channel failure of one of said data buses, in particular a single cable problem or a single connector problem or a single data transceiver problem, or electric interference, such as common-mode interference that disturbs data communication.

6. The elevator safety system according to claim 1, wherein the at least one dual-channel safety node comprises two safety inputs connected to the at least one safety sensor, and wherein the single-channel failure is failure of one of the safety inputs.

7. The elevator safety system according to claim 1, wherein the at least one safety sensor is connected to the at least one dual-channel safety node.

8. The elevator safety system according to claim 1, wherein the at least one safety sensor comprises a safety contact and/or other sensor, such as a limit switch, a position sensor, a speed sensor or a camera.

9. The elevator safety system according to claim 1, wherein the at least one dual-channel safety node is disposed in the car, and the at least one safety sensor is one of a car pulley encoder, a door zone sensor, a car door contact, and a safety contact of an elevator safety gear.

10. The elevator safety system according to claim 1, wherein the safety diagnostics is a separate diagnostics device, or a diagnostics function implemented in a software comprised by the at least one dual-channel safety node and/or by the safety controller.

11. An elevator system comprising:
an elevator shaft and an elevator car configured to transfer passengers and/or cargo in the elevator shaft between landing floors; and
the elevator safety system according to claim 1 allowing a rescue run of the car to a rescue floor.

12. An elevator car rescue run method in the elevator system according to claim 11, the method comprising:
obtaining by the at least one dual-channel safety node safety-related information from the safety sensor;
detecting by the safety diagnostics a single-channel failure of the at least one dual-channel safety node; and
in response to detecting the single-channel failure, determining integrity of the obtained safety-related information,
wherein, in case the safety-related information was determined intact, generating by the safety controller a command allowing a rescue run of the car to a rescue floor using said safety-related information.

13. The method according to claim 12, further comprising:
continuing a current elevator run as the rescue run to the rescue floor; or
performing a new, low-speed rescue run after stopping of the car.

14. The method according to claim 12, further comprising:
performing the rescue run automatically upon occurring of an emergency stopping situation; or
initiating the rescue run locally on-site by pressing a manual drive button; or
initiating the rescue run remotely by sending a message from a remote entity, such as a service center.

15. The method according to claim 12, further comprising:
after arrival of the car to the rescue floor, preventing by the safety system a next elevator run; and
shutting down operation of the elevator until the failure has been repaired.

16. The elevator safety system according to claim 2, wherein said at least one dual-channel safety node is communicatively connected to the safety controller via duplicated messaging, preferably via a duplicated data bus.

17. The elevator safety system according to claim 4, wherein the single-channel failure is a single-channel failure of one of said data buses, in particular a single cable problem or a single connector problem or a single data transceiver problem, or electric interference, such as common-mode interference that disturbs data communication.

18. The elevator safety system according to claim 2, wherein the at least one dual-channel safety node comprises two safety inputs connected to the at least one safety sensor, and wherein the single-channel failure is failure of one of the safety inputs.

19. The elevator safety system according to claim 3, wherein the at least one dual-channel safety node comprises two safety inputs connected to the at least one safety sensor, and wherein the single-channel failure is failure of one of the safety inputs.

20. The elevator safety system according to claim 4, wherein the at least one dual-channel safety node comprises two safety inputs connected to the at least one safety sensor, and wherein the single-channel failure is failure of one of the safety inputs.
